(19) United States
(12) Patent Application Publication
(10) Pub. No.: US 2005/0021434 A1
(43) Pub. Date: Jan. 27, 2005

(54) System and method for whole company securitization of intangible assets

(76) Inventor: Robert W. D'Loren, Oyster Bay Cove, NY (US)

Correspondence Address: JONES DAY, 222 EAST 41ST ST, NEW YORK, NY, 10017, US

(21) Appl. No.: 10/800,220

(22) Filed: Mar. 11, 2004

Related U.S. Application Data
(63) Continuation-in-part of application No. 09/851,895, filed on May 9, 2001.
(60) Provisional application No. 60/203,342, filed on May 9, 2000.

(51) Int. Cl. G06F 17/60

(52) U.S. Cl. 705/36

(57) ABSTRACT

A computer system and methods for whole company securitization of income derived from intellectual property or other intangible assets associated with a business. The systems and methods optimize the use of intangible corporate assets by means of corporate restructuring and third-party financing. A manager entity evaluates intangible assets of a parent business and assists in a corporate restructuring, as a result of which the intangible assets are transferred to a bankruptcy remote special purpose entity, which licenses assets such as patents, brand names and others, back to the operating companies of the parent business. Proceeds from the sale of the intellectual property are used by the parent company for various corporate purposes, such as debt re-financing. The intangible assets are securitized by the manager, so that underlying business debt of the parent business may be transformed into investment-grade.

### CROSS REFERENCE TO RELATED APPLICATIONS

This application is a continuation-in-part of U.S. patent application Ser. No. 09/851,895, filed May 9, 2001, entitled System and Method for Whole Company Securitization of Intangible Assets, which in turn claims priority to U.S. Provisional Application No. 60/203,342, filed May 9, 2000, both of which are hereby incorporated by reference herein in their entirety.

### FIELD OF THE INVENTION

This invention relates generally to the field of computer-assisted business methods, specifically to data processing systems and methods for managing corporate assets. More particularly, the invention relates to computerized systems and methods for optimization of the use of intangible assets by means of corporate restructuring and securitization.

### BACKGROUND OF THE INVENTION

Wealth and growth in today's economy are driven primarily by intangible business assets. Physical and financial assets are becoming commodities, and as such have limited potential to yield above-average returns on investment in the long run. By contrast, intangibles, in combination with other types of complementary assets, may ensure dominant competitive positions and above-average profits for sustained periods of time. In this application the terms intangibles, knowledge assets, and intellectual capital will be used interchangeably, as they essentially refer to nonphysical sources of value, i.e., claims to future benefits. Typically, when a claim to future benefits is legally protected, such as in the case of patents, trademarks, or copyrights, the asset is referred to as intellectual property.

A business entity generally has three basic asset components: working capital as represented by current assets less current liabilities, plant assets, and intangible assets. Broadly, these are the asset categories that all businesses use to participate in their respective industries and to generate profits. These assets are also the underlying basis for the value of a business, which is commonly expressed as the value of its equity and the value of its long-term debt. Thus, the sum of the equity and long-term debt values represents the basis by which all assets of a business were acquired, whether by purchase or internal creation. As noted, in today's economy intangibles are what primarily contributes to many business' earning power and thus to their value. The proper valuation of the intangible assets of a business entity is thus of critical importance. The valuation and funding of intangible assets and their interaction with other business assets are the focus of this application.

Three major types of intangibles may be distinguished according to the mechanism by which the assets are created. These include innovation, organizational structures and practices, and human resources. Successful innovation through research and development is the primary generator of enhanced value in many industries. Strong brand recognition and customer loyalty can also lead to substantial long-term profit advantages over less-known competitors. In many cases unique and creative organizational structures, and the ability to hire and retain the necessary human resources, are critical in creating the intangibles required to establish and keep a competitive advantage. As noted, intangible assets that exist under the protection of law are some times referred to as intellectual property, and include patents, trademarks, copyrights, industrial designs, trade secrets and know-how. Intangible assets may be also be created in the operation of the business. Examples of such assets include customer lists, distribution networks, regulatory compliance know-how, manufacturing practices, and others. Additional examples include assembled and well-trained workforce, advertising programs, training materials, customer loyalty, supplier contacts, management depth and experience, subscriber base and goodwill. This application focuses on intangibles that can be evaluated in terms of present or projected earnings.

In a successful business enterprise intangibles typically interact with tangible and financial assets to create extra value and economic growth. In particular, converting intangible assets into revenues, profits, and value requires a framework of integrated complementary business assets. It will be appreciated that a combination of all three business asset categories is required to make a product, package it, distribute it, sell it, collect payments, and implement many other business functions that are required for running a business. Many business entities utilize to some extent all business asset categories, but frequently are not good at managing them all efficiently. For example, because they are more difficult to evaluate, intangible assets may be overlooked in favor of fixed and working capital assets, the values of which can be readily ascertained. Clearly, in such cases these assets may not be utilized properly, leading to lower business valuation and other disadvantages.

Although some progress has been made in recent years, there is no established methodology for the valuation of intangible assets. In the prior art, some attempts have been made to evaluate intellectual property. Thus, for example, U.S. Pat. No. 6,154,725 discloses a computer system for use in evaluating patents or trademarks. U.S. Pat. No. 6,192,347 teaches decomposition of property into separately valued components in the context of real estate transactions. U.S. Pat. No. 6,154,730 discloses a system for employing the projected receipts of a public facility, such as a stadium, to finance the construction of the facility itself. None of these patents provide a mechanism for the evaluation of the intangible assets of a business entity coupled with a securitization of these assets, that can enhance the overall value of the business. The optimal deployment of the intangible and other business assets, however, requires accurate information about the individual assets, their valuation, and their most productive use in a particular business environment. The disclosure of these patents is hereby incorporated by reference.

Banks and other financial institutions have considered intangible assets, such as established brands, in the past as being important factors in assessing overall business credit. For example, it is known that strong brands produce low cash flow volatility; low volatility commands higher multiples if other factors remaining unchanged, which in turn results in higher lending values. Established brands are recognized as valuable assets creating a stable cash flow from the business owning the brand. The lending institutions may try to control valuable brands during the term of a loan by various methods, such as incorporating negative pledges in loan agreements and inclusion of the established brands in general security agreements. Where circumstances justify, banks may include identifiable intangible assets, such as trademarks, patents and brands, on the company's balance sheet as part of “net tangible worth” when stipulating debt. In some cases brands have been used as collateral, as in the RJR Nabisco leveraged buyout. Brand valuation is also occasionally built into borrowing covenants, such that it is considered an asset for borrowing purposes. However, the prior art fails to disclose whole company securitization of income derived from intellectual property or other intangible assets associated with a business.

Turning to the financing aspect of the invention, prior art methods of securitizing various types of cash flows include asset-backed securities (ABS), which are bonds or notes backed by certain assets. Typically these assets consist of receivables other than mortgage loans, such as credit card receivables, auto loans, manufactured-housing contracts and home-equity loans. In certain cases, however, market was created for asset-backed bonds backed by a music royalty. An example includes the bond issue backed by the future earnings of David Bowie's recordings made prior to 1990. In general, however, the prior art provided no mechanism by which intangible business assets can be evaluated and securitized, and in particular provides no mechanism for whole company securitization of income derived from intellectual property or other intangible assets associated with the business.

### SUMMARY OF THE INVENTION

In accordance with the present invention, a computer-based system and method are provided enabling business entities to issue debt at credit ratings one or more levels above those of the underlying assets, based on whole company securitization of income derived from intellectual property or other intangible assets associated with the business. Thus, one object of the present invention is to securitize the intangible assets, including the intellectual property of a business entity. Such assets may include trademarks, patents, licenses and income associated with various brands. In one aspect of the invention, it is desirable to achieve an investment grade, such as A, BBB or similar credit rating as a result of the securitization of the intangible assets of a business that may have a low credit rating. For example, underlying business debt rated B may be transformed in one aspect of the invention into investment-grade BBB debt by securitizing intangible assets of the business. Organizational restructuring into separate business entity is used in a preferred embodiment, which is expected to effectuate a substantial restructuring of the balance sheet and operations of the parent business.

In accordance with one embodiment, the following approach is used to securitize intangible assets of a business entity. Naturally, it is necessary that the parent business has intangible assets the value of which can be ascertained. As part of the corporate restructuring used in a preferred embodiment, a class of intangible assets of the business are isolated into a bankruptcy-remote entity. In various embodiments the separation of assets can be done through either contribution or sale. Thus, once the intangible assets of the business have been evaluated, the parent business is restructured into two separate entities. One of the resulting entities remains as the operating business, which may manufacture, distribute and sell products, and in general continues to operate in the framework of the original business. The second resulting entity owns the intangible assets of the parent business. It is a bankruptcy remote entity that may form an intellectual property managing company (Manager). The parent business and the Manager enter into agreements having the effect of completing a true market sale of the intangible assets of the parent. In a specific embodiment, backup management may optionally be provided, which is a standby entity that would administer the intellectual property if there is a problem. In addition, in specific embodiments, one can present exit scenarios, which guarantee the right to sell the intangible assets to other users.

In accordance with a present invention, securitizing intellectual property and other intangible assets is accomplished through the concept of controlled rights, which are effectuated through agreements. First, the Manager formed in the corporate restructuring process must meet certain qualifying criteria to enhance the integrity of the transaction. In a specific embodiment, the owner of the intangible assets then licenses the rights to use such assets back to the operating companies pursuant to an arms-length agreement. Thus, the organizational and operational change in the parent business removes certain intangible assets from the supply chain of the original business and licenses the rights to use these assets pursuant to an agreement. To this end, in accordance with the present invention, the intangible assets of the parent entity are evaluated in order to determine their market value. As explained in more detail below, cash flow models may be developed for different intangible assets. For example, regression analysis based on computer models of the brand can be used over a period of time to determine the current value of the projected revenues from the brand over the pre-determined period. It will be apparent that computer models of this type may take into account the lifecycle of various brands involved, the term of one or more patents owned by the business, and others. In this way, according to the invention, future income streams, which are to be derived from separated intangible assets, are quantified and may be sold or licensed to a separate entity.

In a preferred embodiment, the present invention comprises a method for managing the use of intangible assets of a business enterprise, the system comprising a) projecting one or more sources of future cash flow expected to be generated by the intangible assets of the business enterprise, the projection being based at least in part on information obtained over a telecommunications network from third-party sources; b) providing a cash flow estimate expected to be generated by the intangible assets based on the projected one or more sources, and identifying ownership rights associated with the projected one or more sources; c) transferring the identified rights to one or more special purpose vehicles, each in the form of a separate legal entity, in a manner that effectively removes the respective cash flow(s) from the originating entity's bankruptcy estate; d) issuing notes on behalf of at least one special purpose vehicle, using said pooled rights as collateral; e) selling said notes to a grantor trust that issues stock to investors; and f) employing the revenue generated from the sale of said notes to finance at least a portion of the operating costs of the business enterprise.

### BRIEF DESCRIPTION OF THE DRAWINGS

Various aspects, features and advantages of the instant invention are depicted in the accompanying set of figures, which is intended to be illustrative, rather than limiting, in which like reference numerals designate like elements, and:

FIG. 1 is a block diagram of an intellectual property valuation system that can be used in accordance with the present invention;

FIG. 2 illustrates in a block diagram form a simplified organizational structure of a business entity at the closing of re-organization, in accordance with the present invention;

FIG. 3 is a block diagram illustrating a complete transaction structure for whole company securitization of income derived from intangible assets property in accordance with a preferred embodiment of the present invention;

FIG. 4 is an illustration of a computer system for implementing computer processing in accordance with one embodiment of the present invention.

### DETAILED DESCRIPTION OF THE PREFERRED EMBODIMENT

I. Evaluation of Intangible Assets

In general, buyers of assets which are intellectual property intensive purchase these assets based upon some estimated value. When a creditor is considering advancing funds based upon the value of fixed assets, such as equipment, an appraisal is performed and a liquidation value is determined. Then a liquidity adjustment is considered and a liquidation value is concluded. Similar valuation approaches can be employed to determine the liquidation value of intellectual property. It is known to value intellectual property assets with respect to various accounting procedures which conform to Generally Accepted Accounting Procedures (GAAP). There are typically three such procedures: cost, market and income approaches. The valuation approaches are generally known in the art and need not be considered in detail. The reader is directed to the disclosure of U.S. Pat. No. 6,154,725, which is incorporated by reference, for useful background.

In part, these accepted accounting methods rely on the availability of sufficient data relating to the intellectual property portfolio itself. Thus, if the owner of an intellectual property portfolio has used and marketed this property over a sufficiently long time period, then suitable data may be collected to formulate a price based upon one of the above accounting valuation techniques. However, these techniques typically do not provide reliable valuation results when the owner has not collected data or has not used or marketed the portfolio long enough to obtain such data.

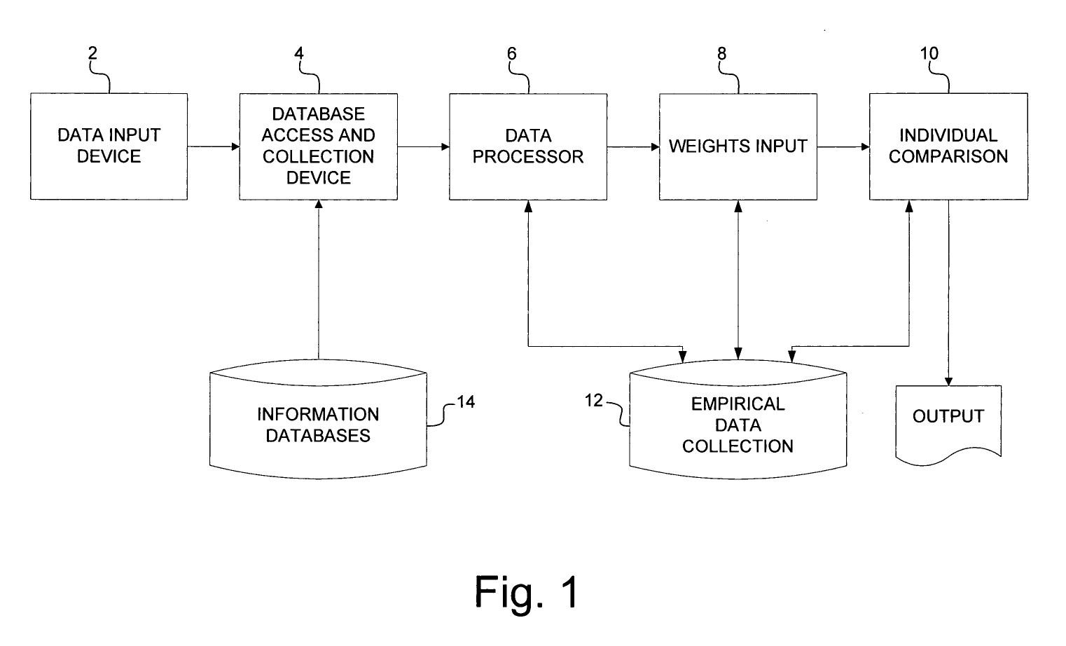

FIG. 1 is a block diagram of an intellectual property valuation system that can be used in accordance with the present invention. In particular, data input device 2 can be used to input data representing the intellectual property portfolio to be evaluated. This data may be, for example, a list of patent numbers and/or trademark registrations, or preferably may include additional information. For example, the additional information may include financial information regarding the business owning the property, or recent performance in the stock market. Data input device 2 is a standard input device and need not be considered in detail. Data entered in device 2 is transmitted to database access device 4.

Device 4 filters the received data to determine which aspects of the received data are to be further analyzed by retrieving information regarding the data from various on-line databases, which aspects need to be transmitted to data processor 6. Device 4 has access to various databases 14 having information concerning the data to be analyzed. For example, with respect to the patent number information, device 4 may access a database to determine if a patent is currently involved in a litigation using such databases as the LITALERT Database, or whether the patent is under reexamination or reissue using databases that provide information regarding the legal status of a patent. Device 4 could further access the LEXIS/NEXIS database to determine whether any newspapers have published any current information regarding the patents, as well as determining whether the patent has been involved in previous lawsuits by accessing the legal reporter files.

Finally, device 4 can also access a full-text patent database to collect different types of information, which could be of two forms. The first type is information derived directly from the patents, such as the number of claims, the length of the independent claims, number of references cited, number of classes searched, whether the patent is a reissue or reexamination, number of years until patent expires or in which group the patent was examined and others. In addition, the indicators may include whether the inventor(s) is a U.S. or foreign citizen, or whether the current owner is U.S. or foreign based. Information regarding U.S. or foreign priority, and whether the cited references have publication dates near the priority dates could also be considered.

The second type of information may be derived from other patents. For example, this information might be how often the patent being evaluated has been cited as a reference for other patents. Similar information could also be collected for trademarks which are included in the intellectual property portfolio from such databases as DIALOG's FEDERAL TRADEMARK SCAN and STATE TRADEMARK SCAN, which store information regarding federal and state trademarks, respectively. Based upon these databases, a user might, for example, determine whether a trademark includes disclaimers to certain words in the trademark and/or how many classes the trademark has been issued for or covers. In addition, recent information affecting the trademark, using services such as LEXIS/NEXIS could be used. Finally, intellectual property which also includes copyrighted work could also be considered in a similar manner. For example, computer software related intellectual property might include both patents on the computer system, as well as copyrights on the software itself.

Device 4 may be any standard device which may interface with the various other databases using, for example, software which is compatible with the software systems of the various databases.

The collected information, including, for example, the first and second types of patent information discussed above, are then transmitted to data processor 6 to process the collected data. The data which does not require processing in data processor 6 may be simply passed to indicator weighing device 8. Data processor 6 processes the collected data as follows: For each of the above indicators, data processor 6 would assign an importance factor, based upon predetermined data stored in empirical database 12, for each of the indicators indicating the importance of the collected data with respect to each indicator. Data processor 6 may include any standard data processor manufactured by various companies including Intel, and preferably may include various functions of artificial intelligence.

Empirical database 12 may be a single database storing all the required empirical data, or may be comprised of several smaller databases each storing different required data used by the system. Empirical database may be any standard database. For example, if device 4 searches the DIALOG database and collects information that a specific patent has been cited over a 100 times, i.e., a citation indicator, data processor 6 might assign an importance factor of 10 on a scale of 1 to 10 to the citation indicator. Similarly, if device 4 determines that the patent was searched in only one class for the class indicator, data processor 6 might assign a 1 on a scale of 1 to 10 to the class indicator. Initially, the class and citation indicators may have the same relative importance. Data processor 6 may determine the values for the citation indicator and for the class factor by comparing the indicators to predetermined indicators having predetermined values. These predetermined indicators may be based upon collected indicators from known intellectual property portfolios.

The determined worth indicators are then transmitted to an indicator weighing device 8, which prioritizes each of the indicators against each other based upon predetermined weighing schemes, which have been determined from known portfolios by also consulting empirical database 12. For example, the citation indicator may be more important, for example twice as important, than the class indicator based upon prior experience.

The weighted indicators are transmitted to indicator comparing device 10, which compares the collection of worth indicators to collections of worth indicators from known intellectual property portfolios by consulting database 12 storing the empirical data. Known distribution or estimation techniques could be used to determine the closest matching known intellectual property portfolio to the intellectual property portfolio which is to be evaluated. Finally, the system may output an approximate value of the evaluated portfolio based on comparison with known or previously estimated portfolio values. The output may be displayed on any display, such as the display systems for electronic data processing equipment.

In a specific embodiment, the present invention may also utilize comparison techniques using neural network pattern matching processes. The specific types of pattern matching techniques implemented by the comparison system/device can be the standard Kohonan and the Back Propagation neural networks, see, for example, U.S. Pat. Nos. 5,146,541 and 5,303,330, incorporated herein by reference. However, other pattern matching techniques could also be used, depending on the required application. In each type of comparison, a neural network is selected that is suitable to the requirements of the application.

In accordance with the present invention, the evaluation of brands is done by establishing the history of the use for the brand, and the level of brand name recognition due to its reputation. Assuming that the underlying business is making apparel and accessories, one useful tool in evaluating the strength of the brand may be the Fairchild 100 Consumer Survey that ranks the most recognizable brands in apparel and accessories. High ranking in such surveys along with the time period during which the brand has maintained its ranking is an important indicator of the strength of the brand name and its inherent value to the business. For companies in relatively bad fiscal condition, having falling sales and decreased marketing, maintenance of rank position speaks directly to the strength of their brands.

II Transaction Structure

A. Corporate Re-structuring

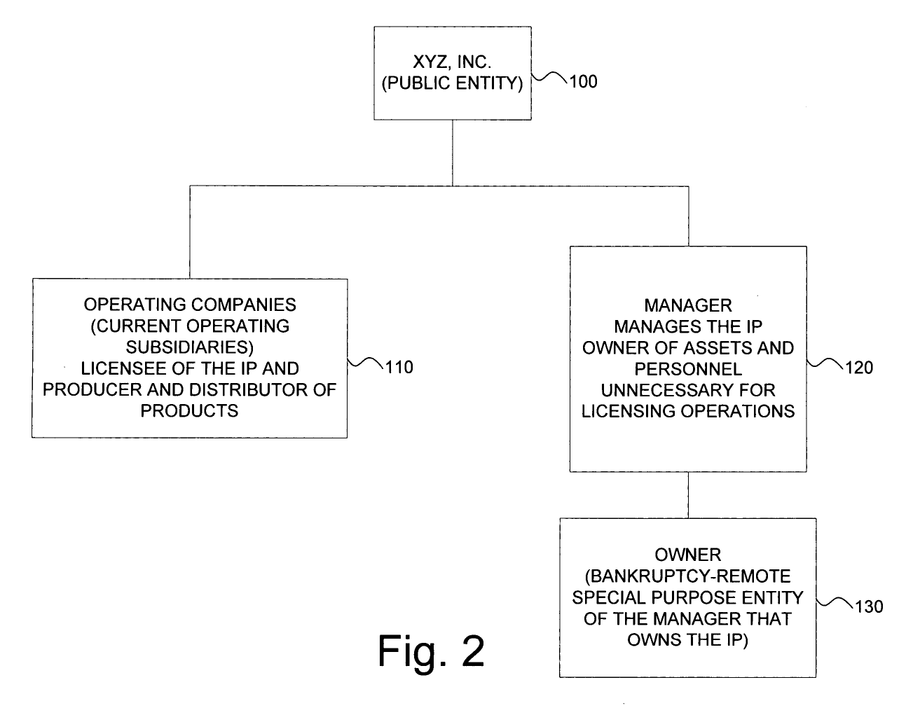

FIG. 2 illustrates in a block diagram form a simplified organizational structure at the closing, used in accordance with the present invention in the case of a single business entity having intangible assets to be securitized. For simplicity, in the following description the term Intellectual Property or “IP” will be used to define the intangible assets, but it should be understood that unless stated otherwise such IP may also contain intangible assets of the company that do not fall within the standard definition of intellectual property.

Shown in FIG. 2 at 100 is the parent business entity XYZ, which may be a publicly traded company owned by its shareholders. In accordance with the present invention the XYZ parent company is re-structured into one or more “Operating Companies” 110, which may include all current operating subsidiaries. As described below, operating company(s) 110 license the business entity's brand and any other IP, and produce and distribute all products of the parent company XYZ.

In addition, the parent company forms in accordance with the invention a subsidiary “Manager” entity 120. Manager 120 manages the IP assets that are being securitized. In a specific embodiment, the Manager may be a newly created subsidiary of XYZ company, for example structured as LLC. Preferably, it is qualified and must maintain special purpose entity (SPE) status. Manager 120 in a preferred embodiment has all of the assets (including all current, future and renewal IP assets) and personnel necessary for the exploitation of the intangible assets of the parent XYZ. Preferably, the intangible assets are contributed to Manager 120 at or prior to closing through, for example, a capital contribution agreement. By means of the restructuring, IP assets of XYZ are insulated from the negative impact of production operations and market cycles.

In accordance with the invention, the IP assets being securitized are sold to an “Owner” entity 130 in a true sale for securitization purposes. Owner 130 in a specific embodiment is a newly created LLC subsidiary of Manager 120. Preferably, it must also qualify and maintain SPE status. As noted, the Owner 130 has all current IP assets sold to it by the Manager 120. In a preferred embodiment all future and renewal IP assets are sold to the Owner through, for example, a management agreement. In a specific embodiment, compensation for the future assets may be included and accounted for in, for example, excess Management Fees, as described below. As explained next, consideration for the sale of the IP assets is provided in a preferred embodiment by loan proceeds and may include an equity stake in the Owner. In a preferred embodiment, Manager 120 may enter into a management agreement with the Owner 130 to exploit the IP on behalf of the Owner, in exchange for a Management Fee. In the case when consideration is obtained using a loan, Manager 120 may retain a portion of the loan proceeds (obtained through the sale of the IP to the Owner) for the initial capitalization of the Manager.

With reference to FIG. 2, in accordance with the invention the Operating Companies 110 enter into a market-rate master license agreement with the Owner 130, so that the Operating Companies 110 may continue to utilize the IP of the parent and may operate on a going-forward basis in a manner consistent with the normal production operations of the parent entity XYZ. Preferably, the Operating Companies 110 can enter into a non-exclusive, market rate manufacturing and sourcing agreement with the Owner, such that the Operating Companies may continue to fulfill any distribution obligations of the parent company XYZ, under certain license agreements, of the Owner on a going-forward basis in a manner consistent with standard operations by the parent XYZ. All transactions indicated above are at arms-length.

In summary, through the creation of a Manager 120, in one embodiment a newly created operating subsidiary of the parent XYZ entity, the Operating Companies will become a third-party IP licensee (under a Master License Agreement), manufacturing and distributing products within the United States and supplying product to certain international markets. Preferably, under the terms of the Master License Agreement, XYZ will be subject to customary terms, including the payment of royalties to the Owner and maintaining certain performance criteria in a manner consistent with a license of this nature. Consistent with the terms in XYZ's existing licenses with third parties, the Master License Agreement may require that the Operating Companies maintain a standard of performance and fiscal strength. Should any material terms of the license be broken, the Manager 120, may have the right and in certain instances may be required to terminate the Master License Agreement on behalf of the Owner.

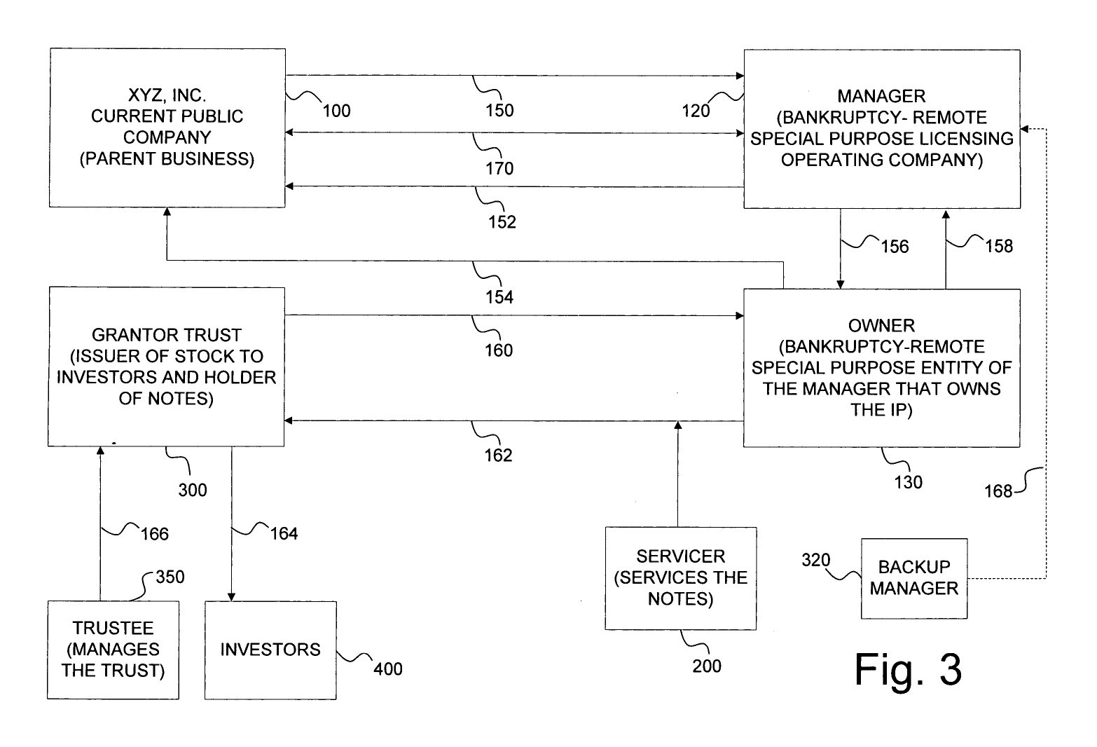

In accordance with the corporate re-structuring, Manager 120 will be required, in return for Administration Fees, to manage and exploit the IP on a best efforts basis. As shown in FIG. 3 at 168, should the Manager not perform its duties as required, or if the Manager cannot maintain its status as a Qualified Manager, the Owner may have the right to terminate the Manager and install a Back-up Manager. The Back-up Manager will, in return for a pre-determined fee, continue to administer the IP, while pursuing alternative forms of exploitation that will protect and enhance the cash flow of the Owner. The options available (the Exploitation Rights) may include, without limitation, the negotiation of a Retail Put Contract, the identification of a replacement Qualified Manager and/or Qualified Master Licensee and ultimately, upon default, the immediate liquidation of the IP.

B. Overview of the Intellectual Property

As indicated above, the intellectual property for the purposes of the securitization consists of trademarks, patents and all existing, renewal and future licenses of XYZ, as well as all income generated by such license collateral (collectively “the Collateral IP”).

Although the nature and scope of the IP involved in a particular transaction will vary, an example will serve as an illustration. Assume that XYZ company has entered into several separate licensing agreements permitting the licensees to make, use and sell patented machines, processes and/or products, and further design and market selected products under the XYZ brand name in specific markets. Under the standard terms of such licensee arrangements, products designed by licensees, as well as related advertising, must be approved in advance by XYZ. In addition, in most cases XYZ has the right to monitor the quality of the licensed products on an ongoing basis. The valuation of the IP is done in accordance with the principles discussed in Section I above.

The LP licenses represent the obligation of the licensees to pay royalties to XYZ on the products manufactured and sold by the licensees. Royalties are typically paid quarterly, in arrears based upon a percentage of net sales, with most licenses providing for minimum royalties (typically based upon minimum sales requirements). The licenses are typically three-to-five years in length and may include renewal options based upon the licensee meeting prior performance criteria. In addition, although royalty payments are typically made in U.S. dollars, XYZ may forward foreign exchange contracts to hedge significant net currency exposure.

C. The Securitization

FIG. 3 is a block diagram illustrating a complete transaction structure for whole company securitization of income derived from intellectual property in accordance with a preferred embodiment of the present invention. FIG. 3 illustrates in further detail the structural relationship shown at closing in FIG. 2, where for simplicity the parent XYZ and the Operating Companies are shown in one block 100, and further illustrates the interconnection between different entities and the exchange mechanisms used in a preferred embodiment.

As shown in FIG. 3, in a preferred embodiment parent business entity XYZ may be a publicly traded company having established intellectual property and other intangible assets, designated as collateral IP. At 150, in accordance with the invention, XYZ assigns and transfers all such collateral IP and all related licensing assets, offices, and personnel to Manager 120, which is a licensing subsidiary of XYZ. Preferably, Owner 130 is a special purpose bankruptcy-remote entity of the Manager. The Manager 120 and the Parent Business 100 enter into a Management agreement at 170. Pursuant to this agreement, the Manager 120 sells collateral IP assets such as patents, trademarks, licenses, and income rights to Owner 130 at 156. In return, at 158 in the illustrated embodiment the Manager receives from the Owner securitization proceeds. The Manager passes securitization proceeds on to the Operating Companies 100 at 152. As illustrated, there is optionally a backup manager 320 to take the place of the manager at 168 if the manager proves unsatisfactory in fulfilling its duties.

As further illustrated in the figure at 154, the Owner enters into a Master License Agreement with the Operating Companies granting them a non-exclusive license to manufacture, distribute, and sell products under the collateral IP. A separate Manufacturing and Sourcing Agreement between the parties regulates the obligation of the Operating Companies with respect to the use of the collateral IP. The Owner 130 may use the proceeds from the licensing agreement to pay the Manager 120 for managing the IP. The Owner 130 then issues notes secured by a lien on the IP.

At 300, FIG. 3 illustrates a Grantor Trust. At 162, the Grantor Trust buys the notes sold by the Owner 130 secured by a lien on the IP. The Grantor Trust 300, which holds the notes, sells stock in the trust to individual or corporate investors at 164 and uses the proceeds of the securitization to pay for the notes issued by the Owner 130 at 160. A Trustee 350 manages the grantor trust at 166. The Grantor Trust may sell common stock or preferred stock in the trust and may pay dividends to the investors 400.

At 200, FIG. 3 illustrates a servicing corporation “Servicer” that performs servicing on the notes issued by the Owner.

While the invention has been described by recitation of its various aspects/features and illustrative embodiments thereof, those skilled in the art will recognize that alternative elements and techniques, and/or combinations and sub-combinations of the described elements and techniques, can be substituted for, or added to, those described herein. The present invention, therefore, should not be limited to, or defined by, the specific structures, apparatuses, methods, and articles of manufacture described herein, but rather by the appended claims, which are intended to be construed in accordance with well-settled principles of claim construction.

III. The Computer System

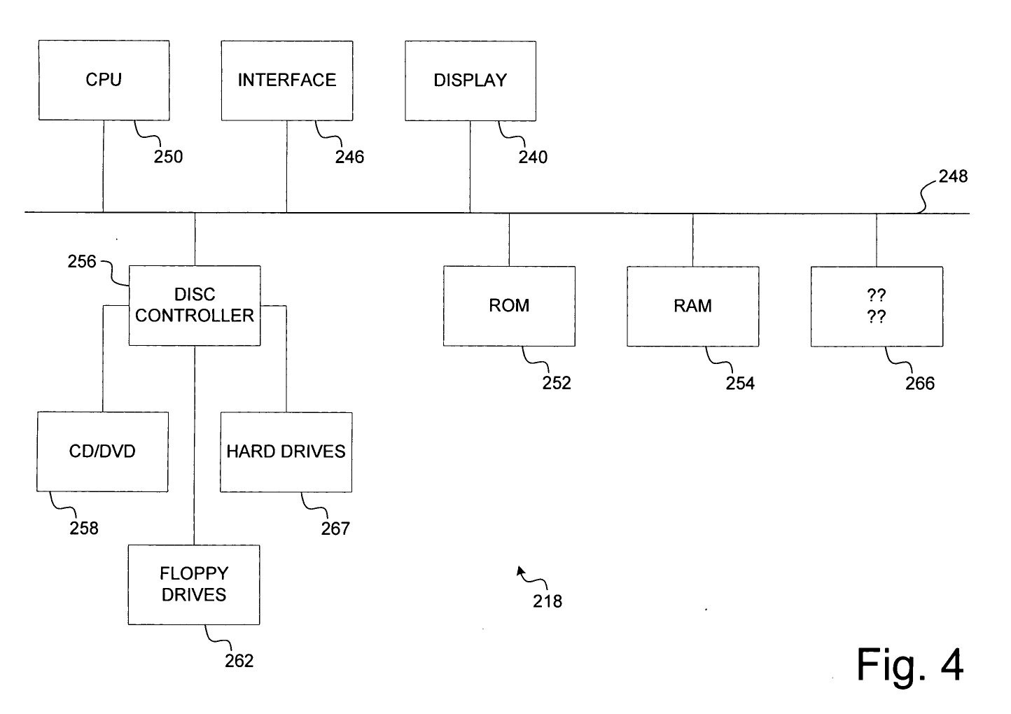

FIG. 4 is an illustration of main central processing unit for implementing computer processing in accordance with one embodiment of the present invention. In FIG. 4 computer system 218 includes central processing unit 234 having disk various drives. Typically, these may include a floppy disk drive 262 As illustrated, data bus 248 serves as the main information highway interconnecting the other components of the computer system. CPU 250 is the central processing unit of the system performing calculations and logic operations required to execute any programs. Read-only memory 252 and random access memory 254 constitute the main memory of the computer, and may be used to store simulation data. Disk controller 256 interfaces one or more disk drives to the system bus 248. These disk drives may be floppy disk drives such as 262, internal or external hard drives such as 260, or CD ROM or DVD drives such as 258. A display interface operates a display 240 and permits information from the bus 248 to be displayed. Communications with the external devices can occur on communications port 266. It will be appreciated that in a preferred embodiment the computer system 218 may have access to the Internet.

In a preferred embodiment, the system of the present invention provides for the securitization of the future cash flows from licensing the intangible assets in the following manner. Computer programs implemented pursuant to the discussion in Section I above provide means for predicting the licensing revenues or cash flows and the purchase by the Borrower 130 of the requisite rights. The computer system in a preferred embodiment has the ability to employ both historical and prospective third party data and data unique to the underlying intangible asset, as well as consideration of a variety of other complementary variables, including, likely business cycles, how well the asset and similar assets are performing nationally and internationally, and a host of other factors to predict likely receipts or cash flows and to make adjustments on such predictions on a periodic basis.

1. A method for managing the use of intangible assets of a business enterprise, comprising:
a) projecting one or more sources of future cash flow expected to be generated by the intangible assets of the business enterprise, the projection being based at least in part on information obtained over a telecommunications network from third-party sources;
b) providing a cash flow estimate expected to be generated by the intangible assets based on the projected one or more sources, and identifying ownership rights associated with the projected one or more sources;
c) transferring the identified rights to one or more special purpose vehicles, in a manner that effectively removes the respective cash flow(s) from the business enterprise's bankruptcy estate;
d) issuing notes on behalf of at least one special purpose vehicle, using said transferred rights as collateral;
e) selling said notes to a grantor trust that issues stock to investors; and
f) employing the revenue generated from the sale of said notes to finance at least a portion of the operating costs of the business enterprise.

2. The method of claim 1 wherein the stock issued by the grantor trust is preferred stock.

3. The method of claim 1 wherein the grantor trust is a Delaware grantor trust.

4. The method of claim 1 wherein the grantor trust employs the revenue generated from the sale of said stock to purchase additional notes.
